(19) United States
(12) Patent Application Publication
(10) Pub. No.: US 2016/0184932 A1
(43) Pub. Date: Jun. 30, 2016

(54) DECOILING AND BLANKING MACHINE USING LASER CUTTING TECHNOLOGY AND PROCESSING METHOD THEREOF

(71) Applicant: Zhenquan WU, Shandong (CN)

(72) Inventor: Zhenquan Wu, Jinan, Shandong (CN)

(21) Appl. No.: 14/909,990

(22) PCT Filed: Apr. 4, 2014
(86) PCT No.: PCT/CN2014/074828

§ 371 Date: Feb. 4, 2016

(30) Foreign Application Priority Data
Aug. 7, 2013 (CN) 201310341109.7

(51) Int. Cl. B23K 26/38; B23K 26/08

(52) U.S. Cl. CPC B23K 26/38; B23K 26/0846; B23K 2201/006

(57) ABSTRACT

The present invention discloses a decoiling and blanking machine using laser cutting technology, comprising a decoiler, a leveller, a servo feeder, a laser cutting device, a stacking system and a waste treatment system processing waste material, wherein the laser cutting platform is fixed to the foundation between the servo feeder and the stacking system, and the laser cutting device which can be used for cutting the moving strip material is fixed to the laser cutting platform. According to the technical scheme of the present invention, fast cutting and blanking can be achieved by combining the ordinary coil feed line with the laser cutting device through the utilization of a new-type laser cutting platform. At the same time, equipment costs and energy consumption are reduced, and given the fast conversion of product specifications, the machine is suitable for the production of various batches.

### FIELD OF THE INVENTION

The invention relates to a decoiling and blanking machine using laser cutting technology and its processing method, more specifically, particularly to a decoiling and blanking machine and its processing method by combining the ordinary coil feed line with the laser cutting device through the utilization of a new-type laser cutting platform.

### DESCRIPTION OF THE RELATED ART

Metal blanking process, the most basic procedure in the production of work pieces such as hardware materials and automobile parts, etc., requires a lot of manpower and resources for production, and how to save costs, improve efficiency and quality are much concerned by manufacturers. At present, the popular way of the production in China is to decoil and flatten the coil stock and send it into the press machine for blanking via a feeder. A massive waste in investment is caused as a result of the demand for manufacture of blanking moulds in large quantity, high equipment investment and cost of subsequent use as well as low equipment flexibility.

Laser cutting is a hot cutting method that utilizes the focused laser beam as the primary heat source, since the laser beam is confined in a very small space, an intensive energy is sent out to heat local area quickly and evaporate the processing location. Besides, due to the extremely confined energy, a little heat is transferred to other portions of the steel, giving rise to slight deformation. Laser can cut the blank of complex shape precisely, demanding no further processing. Without the aid of a mould, the blank of complex shape can be processed at high flexibility.

The utility model patent document (Patent No.CN201120245764.9) claims a conveying chain or conveying belt type laser cutting platform which can not only attain the support to the material but also match the movement of driven material in laser cutting.

The utility model patent document (Patent No.CN201120120604.1) claims a laser cutting device that can blank the moving strip material, which consists of a laser generator, a laser cutting head and X-axis, Y-axis and Z-axis driving units. Driven by X-axis, Y-axis and Z-axis driving units, the laser cutting head archives the cutting of the moving material. Furthermore, the existing laser cutting device basically processes a single sheet of static material. There has no structure-tailored laser cutting device able to process blanking of metal strip in a continuous way at present.

### SUMMARY OF THE INVENTION

The present invention has been made in view of the above-mentioned circumstances in the prior art, and has for its object to provide a decoiling and blanking machine using laser cutting technology and its processing method.

The present invention claims a decoiling and blanking machine using laser cutting technology, which comprises a decoiler fixed on a base unfold coil stock, a leveller to flatten coil stock, a servo feeder to feed strip material, a stacking system collecting material and a waste treatment system processing waste material; characterized in that: the laser cutting platform is fixed to the base between the servo feeder and the stacking system, and the laser cutting device which can be used for cutting the moving strip material is fixed to the laser cutting platform, and fast cutting and blanking is achieved by combining the ordinary coil feed line with the laser cutting device through the utilization of a new-type laser cutting platform.

The base has the function of fixation and support, and the decoiler will unfold the coil stock to be then flattened by the leveller for purpose of satisfying the flatness of the blanking. The servo feeder will convey the strip material to the laser cutting platform at the set velocity, and the laser cutting device is applied to cut the moving strip material.

As claimed in the invention of the decoiling and blanking machine using laser cutting technology, the leveller and the servo feeder adopt a separate structure or an integrated structure for flattening and feeding. No matter what option is made, the requirement can be met as long as the strip material is flattened and conveyed before entering the cutting platforms.

As claimed in the invention of the decoiling and blanking machine using laser cutting technology, the laser cutting device comprises a frame, a movable transverse beam and a movable support, a slider and a laser cutting head, wherein the movable transverse beam runs on the X-axis; X-axis servo motor is applied to drive the movable transverse beam to run in the direction of X-axis; the movable transverse beam can be with a gantry structure or a single-arm structure.

The movable transverse beam is mounted with a movable support, the moving direction of which is defined at the Y-axis. Y-axis servo motor is applied to drive the movable support to run in the direction of Y-axis; the movable support is provided with a slider which is driven by Z-axis servo motor, and the laser cutting head is fixed on the slider of Z-axis.

As claimed in the invention of the decoiling and blanking machine using laser cutting technology, the X-axis servo motor and the Y-axis servo motor separately drives the movable transverse beam and the movable support by means of a ballscrew or the gear-and-rack engagement; if the gear-and-rack engagement is adopted, the output shaft of X-axis servo motor is set with a gear, and the frame is set with a rack to engage with the gear, the output shaft of Y-axis servo motor is set with a gear, and the movable transverse beam is set with a rack to engage with the gear.

As claimed in the invention of the decoiling and blanking machine using laser cutting technology, comprising a laser cutting platform which further comprises a bearing transverse beam containing a left transverse beam and a right transverse beam to be set in parallel, wherein the two transverse beams are set with a driving shaft, a driven shaft, a conveying chain or a conveying belt and a tension adjusting device; the driving shaft and the driven shaft are respectively set at both ends of the two transverse beams and the driving shaft and the driven shaft are provided with a gear which drives the conveying chain or the conveying belt; the conveying chain or the conveying belt are equally spaced by several supporting racks on the outside surface, the two transverse beams are set with a horizontal board which supports the conveying chain or the conveying belt; a powered roller which is set at one end of the driving shaft (40) connects with a power unit. The left transverse beam and the right transverse beam are set in parallel, the driving shaft and the driven shaft are respectively set at both ends of the two transverse beams; the gears set on the driving shaft and the driven shaft are used to drive the conveying chain or the conveying belt, and the several replaceable supporting racks set on the outside surface of the conveying chain or the conveying belt are used to support the work piece being cut; two adjacent racks should be set at some space to allow the laser to smoothly cut the work piece on the supporting racks and also to minimize the damage of the laser to the supporting racks. The power unit drives the driving shaft and realizes the synchronous movement of the supporting racks and the strip material conveyed from the servo feeder, so as to prevent the rack from scratching the lower surface of the strip material and guarantee the laser cutting device to blank under the movement of cutting material.

Wherein, the supporting racks are detachably fixed on the conveying chain or the conveying belt, with the exposed face being zigzag. The supporting racks are easily damaged parts that require regular replacement and are therefore set detachably. The exposed face of supporting racks is set to be zigzag, in favor of reducing the damage of the laser to the supporting racks.

As claimed in the invention of the decoiling and blanking machine using laser cutting technology, comprising a feeding device used to convey the coil stock to the decoiler, wherein the feeding device consists of a coil cradle, a car body, a guide rail and a driving motor.

As claimed in the invention, the decoiling and blanking machine using laser cutting technology comprises a stacking system collecting finished products and a waste treatment system collecting waste material.

As claimed in the invention, the processing method of the decoiling and blanking machine using laser cutting technology comprising the following steps: a). Servo feeding, assuming that the servo feeder conveys the strip material in the velocity of v to the laser cutting platform beneath the laser cutting device; b). Positioning the starting point of cutting, driven by X-axis servo motor and Y-axis servo motor, the laser cutting head is moved to the starting point of cutting, and driven by Z-axis servo motor, the laser cutting head is moved to an appropriate height from the strip material to meet the requirements of laser cutting; c). Velocity stacking, assuming that the running velocity of X-axis servo motor and Y-axis servo motor are vₓ and v_{y} respectively when cutting static strip, then, the running velocity of X-axis servo motor and Y-axis servo motor are vₓ+v, v_{y} respectively when cutting moving strip; d). Executing pattern cutting, driven by the servo motor in the laser cutting device, the laser cutting head operates pattern cutting at the stacked velocity; e)Returning to the starting point of cutting, after one cutting cycle is finished, the laser cutting head returns to the starting point under the driving of a servo motor for next cycle; f) Repeating step b), c), d) and e) until the strip processing completes.

Certainly, in order to improve the cutting precision, the invention can also cut the strip material in static condition, after finishing the first batch of material, more strip material can be fed for cutting, and repeat the cycle; although the work efficiency is reduced to some degree, the invention can attain the goal of saving material. This can take the place of the regular laser cutting system and simplify the technological process of part preparations.

The beneficial effect of the invention is: As claimed in the invention of the decoiling and blanking machine using laser cutting technology, wherein a laser cutting device that can blank the moving strip material is provided to make the best of raw material and also increase 5-7% material utilization ratio through reasonable stock layout of the strip material; meanwhile, the decoiling and blanking machine composed of an expensive press machine and the frequently-replaced moulds are replaced, the equipment cost and the energy consumption are reduced. Given the fast conversion of product specifications, the machine is quite suitable for the production of various batches. As claimed in the invention, the processing method of the decoiling and blanking machine using laser cutting technology, wherein efficient cutting of moving strip material can be achieved on a patented laser cutting platform by stacking the feeding velocity of a servo feeder on the X-axis.

The whole set of the decoiling and blanking machine using laser cutting technology consists of a feeding trolley, a decoiler, a leveller, a buffer looper, a servo feeder (if an integrated structure for flattening and feeding is adopted, the leveller and the buffer looper can be removed to reduce floor space), a laser cutting device, a laser cutting platform, a stacking system, a waste treatment system, a hydraulic and pneumatic system and an electrical control system, the machine achieves the automatic blanking of the metal strip through the three-dimension movement cutting of a laser cutting head on the laser cutting platform, taking the place of a press machine and a mould.

### BRIEF DESCRIPTION OF THE DRAWINGS

FIG. 1 is the structural diagram of the decoiling and blanking machine claimed in the invention;

FIG. 2 is the structural diagram of a laser cutting device claimed in the invention from the front;

FIG. 3 is the structural diagram of a laser cutting device claimed in the invention from the left;

FIG. 4 is the structural diagram of a laser cutting device claimed in the invention from the top;

FIG. 5 is the top view of the laser cutting device of FIG. 3;

FIG. 6 is the structural diagram of the joint between the movable support and the movable transverse beam;

FIG. 7 and FIG. 8 are the structural diagram of a laser cutting device claimed in the invention from the front and the top, respectively.

Wherein, 1-feeding device, 2-decoiler, 3-leveller, 4-buffer looper, 5-servo feeder, 6-laser cutting device, 7-laser cutting platform, 8-stacking system, 9-waste treatment system, 10-base, 11-frame, 12-movable transverse beam, 13-14 X-axis servo motor, 15-Y-axis servo motor, 16-Z-axis servo motor, 17-movable support, 18-laser cutting head, 19-motor cabinet, 21-X-axis guide rail, 22-X-axis slider, 23-gear, 24-rack, 25-gear, 26-rack, 27-Y-axis guide rail, 28-Y-axis slider, 29-ballscrew, 30-slider, 31-supporting board, 32-gland, 33-spacer bush, 34-36 deep groove ball bearing, 37-transverse beam, 38-conveying chain, 39-supporting rack, 40-driving shaft, 41-gear, 42-driven shaft, 43-left transverse beam, 44-right transverse beam, 45-tension adjusting device, 46-powered roller; 1-1 coil cradle, 1-2 car body, 1-3 guide rail and 1-4 driving motor.

### DETAILED DESCRIPTION OF THE PREFERRED EMBODIMENTS

The invention will be further described in combination with drawings and embodiments.

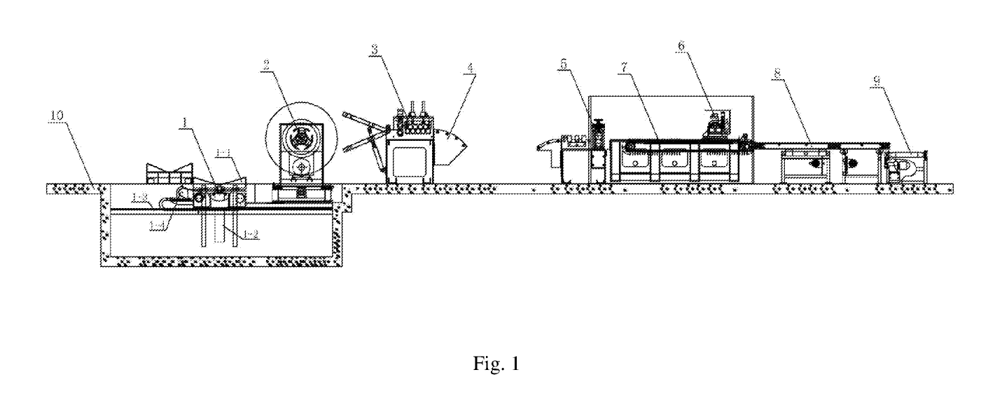

As shown in FIG. 1, the structural diagram of the decoiling and blanking machine claimed in the invention comprises feeding device 1, decoiler 2, leveller 3, buffer looper 4, servo feeder 5, laser cutting device 6, laser cutting platform 7, stacking system 8 and waste treatment system 9, all of which are fixed on base 10. The feeding device 1 is used to convey the coil stock to the decoiler 2 for unfolding, the leveller 3 will flatten the unfolded coil stock, and the buffer looper 4 is set at the back of the leveller 3 for storing the strip material to guarantee the smooth work of the machine.

After flattened on the leveller 3, the strip material enters the servo feeder 5 that conveys the strip material at the set velocity to the laser cutting platform 7. The laser cutting device comprises a laser generator and a laser cutting head 18 that performs the three-dimension movement cutting of the moving strip material on the laser cutting platform under the action of a driving unit. The blank formed after cutting enters the stacking system (8) behind that stacks the blank for the convenience of handling and storage. The marginal material and the waste material left in cutting enter the waste treatment system (9) behind that processes them in a centralized manner. The feeding device consists of a coil cradle 1-1, a car body 1-2, a guide rail 1-3 and a driving motor 1-4, wherein the driving motor 1-4 is used to drive the car body on the guide rail 1-3.

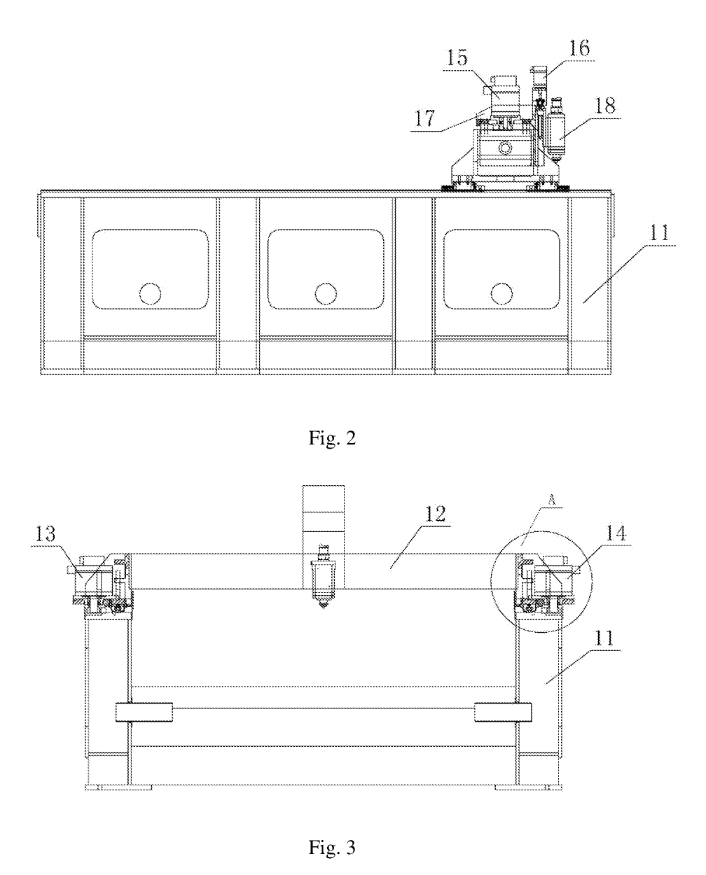

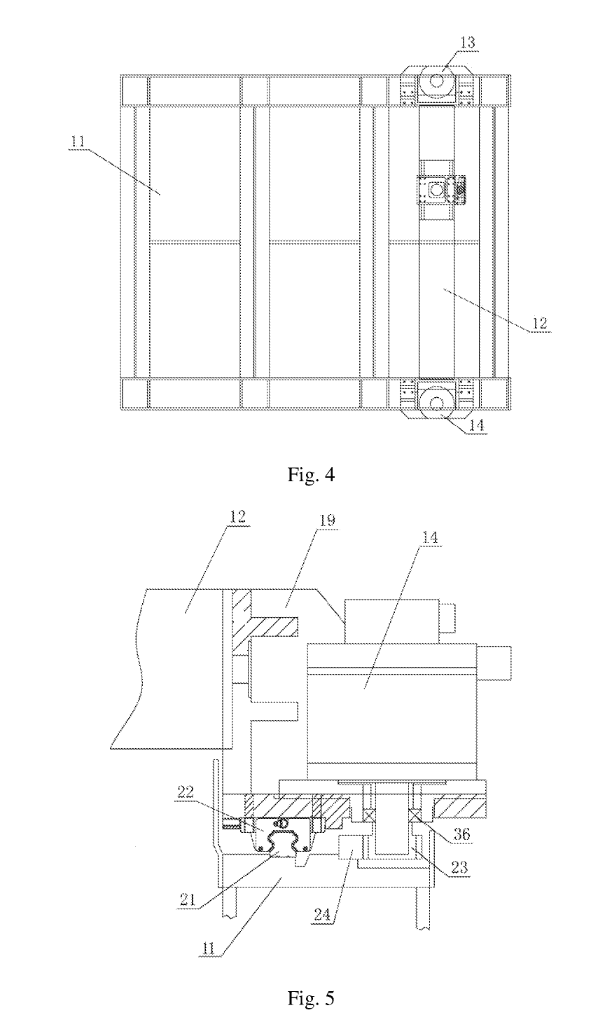

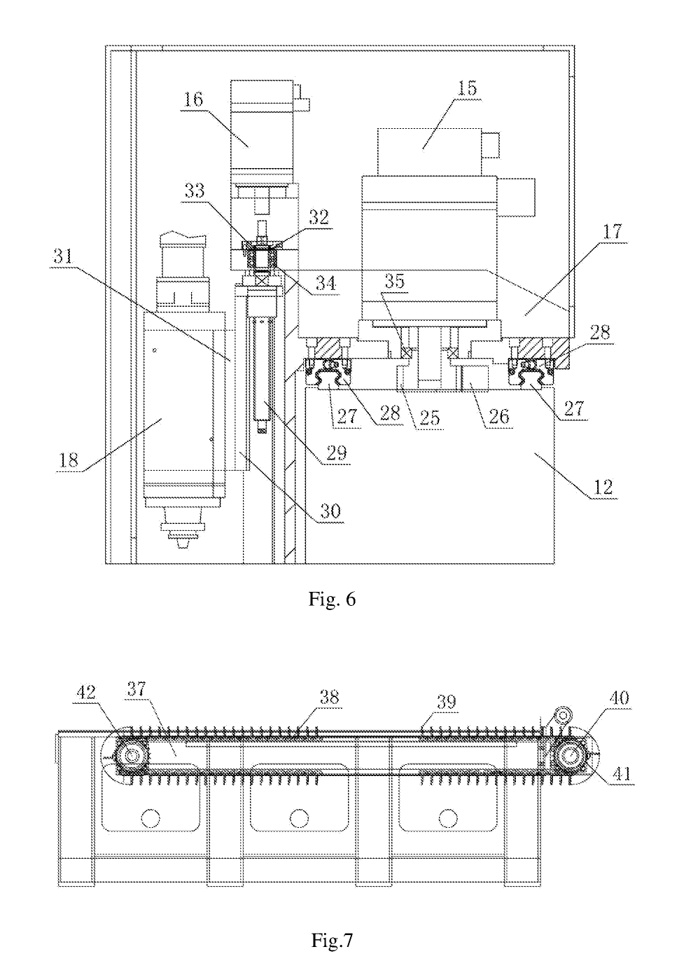

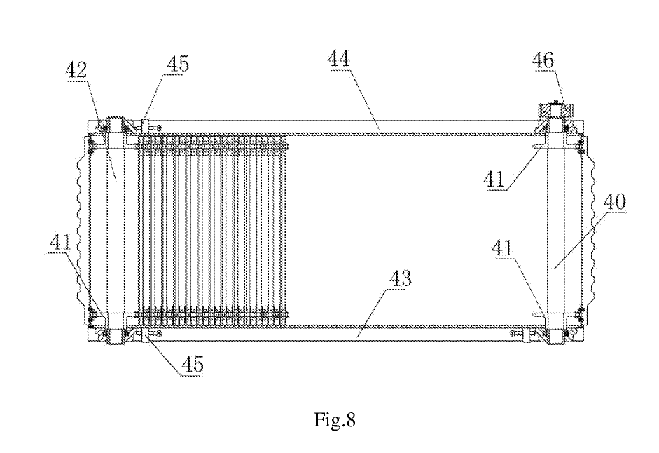

As shown in FIGS. 2, 3 and 4, the structural diagram of a gantry-type laser cutting device claimed in the invention from the front, the left and the top comprises a frame 11, a movable transverse beam 12 and a laser cutting head 18, wherein the frame 11 is used for fixation and supporting, and the movable transverse beam 12 is located on the frame 11 and set along the width of the frame 11. The movable transverse beam 12 runs along the length of the frame 11 under the action of the servo motors 13 and 14. The movable support 17 is set on the movable transverse beam 12 and runs along the length Y-axis of the movable transverse beam 12 under the action of the servo motor 15. Z-axis servo motor 16 can drive the laser cutting head 18 to move on the plane perpendicular to the frame 11 for implementation of its follow-up function.

In this way, the laser cutting head 18 performs the three-dimension movement to complete laser cutting of the moving strip material under the action of the X-axis servo motor, the Y-axis servo motor and the Z-axis servo motor.

Certainly, the movable transverse beam of the laser cutting device can also be with a single-arm structure. Details will not be given here.

As shown in FIG. 7, the structural diagram of a laser cutting device 7 claimed in the invention comprises a transverse beam 37, a conveying chain 38, a supporting rack 39, a driving shaft 40, a gear 41, a driven shaft 42, a left transverse beam 43, a right transverse beam 44, a powered roller 46 and a tension adjusting device 45; wherein, the transverse beam 37 is used for fixation and supporting and composed of the left transverse beam 43 and the right transverse beam 44. Two conveying chains 38 which are supported by multiple supporting racks 39 are set along the length of the transverse beam 37, and there should be enough gap between the supporting racks 39 to provide support for the strip material and convenience for laser cutting. The driving shaft 40 is connected with the driving unit to realize rotation; the gear 41 is set on the driving shaft 40 and engages with the conveying chains 38 so that the supporting racks 39 are driven to move under the action of the driving shaft 40.

The processing method of the decoiling and blanking machine using laser cutting technology as claimed in the invention is realized through following steps:

a) Servo feeding, assuming that the servo feeder conveys the strip material in the velocity of v to the laser cutting platform beneath the laser cutting device;

b) Positioning the starting point of cutting, driven by X-axis servo motor and Y-axis servo motor, the laser cutting head is moved to the starting point of cutting, and driven by Z-axis servo motor, the laser cutting head is moved to an appropriate height from the strip material to meet the requirement of laser cutting;

c) Velocity stacking, assuming that the running velocity of X-axis servo motor and Y-axis servo motor are vₓ and v_{y} respectively when cutting static strip, then, the running velocity of X-axis servo motor and Y-axis servo motor are vₓ+v, v_{y} respectively when cutting mobile strip;

d) Executing pattern cutting, driven by the servo motor in the laser cutting device, the laser cutting head operates pattern cutting at the stacked velocity;

e) Counting from the starting point of cutting, after one cutting cycle is finished, the laser cutting head 18 returns to the starting point under the driving of a servo motor for the next cycle;

f). Repeating steps b), c), d) and e) until the strip processing completes.

Certainly, in order to improve the cutting precision, the invention can also cut the strip material in static condition, after finishing the first batch of material, more strip material can be fed for cutting, and repeat the cycle; although the work efficiency is reduced to some degree, the invention can attain the goal of saving material. This can take the place of the regular laser cutting system and simplify the technological process of part preparation.

1. A decoiling and blanking machine using laser cutting technology, comprising a decoiler (2) fixed on a base (10) to unfold coil stock, a leveller (3) to flatten coil stock, a servo feeder (5) to feed strip material, a laser cutting device (6), a laser cutting platform (7), a stacking system (8) collecting material and a waste treatment system (9) processing waste material; wherein the laser cutting platform (7) is fixed to the base between the servo feeder (5) and the stacking system (8), and the laser cutting device (6) for cutting the moving strip material is fixed to the laser cutting platform (7).

2. The decoiling and blanking machine using laser cutting technology according to claim 1, wherein the leveller (3) and the servo feeder (5) adopt a separate structure or an integrated structure for flattening and feeding.

3. The decoiling and blanking machine using laser cutting technology according to claim 1, wherein the laser cutting device (6) comprises a frame (11), a movable transverse beam (12) and a movable support (17), a slider (30) and a laser cutting head (18), wherein the movable transverse beam (12) runs on the X-axis; the movable transverse beam (12) runs in the direction of X-axis under the drive of the X-axis servo motor;
the movable transverse beam (12) is mounted with the movable support (17), the moving direction of which is defined at the Y-axis, the movable support (17) runs in the direction of Y-axis under the drive of the Y-axis servo motor; the movable support (17) is provided with the slider (30) which is driven by the Z-axis servo motor, and the laser cutting head (18) is fixed on the slider (30).

4. The decoiling and blanking machine using laser cutting technology according to claim 1, wherein the laser cutting platform (7) comprises a supporting transverse beam (37) containing a left transverse beam (43) and a right transverse beam (44) to be set in parallel, wherein the two transverse beams are set with a driving shaft (40), a driven shaft (42), a conveying chain (38) or a conveying belt and a tension adjusting device (45); the driving shaft (40) and the driven shaft (42) are respectively set at both ends of the two transverse beams, the driving shaft (40) and the driven shaft (42) are provided a gear (41) which drives the conveying chain or the conveying belt; the conveying chain (38) or the conveying belt are equally spaced by several supporting racks (39) on the outside surface, the two transverse beams are set with a horizontal board which supports the conveying chain (38) or the conveying belt; a powered roller (46) which is set at one end of the driving shaft (40) connects with a power unit.

5. The decoiling and blanking machine using laser cutting technology according to claim 1, further comprising a feeding device (1) used to convey the coil stock to the decoiler (2), wherein the feeding device (1) consists of a coil cradle (1-1), a car body (1-2), a guide rail (1-3) and a driving motor (1-4).

6. A processing method of the decoiling and blanking machine using laser cutting technology according to claim 1, comprising the following steps:
a) servo feeding, assuming that the servo feeder (5) conveys the strip material in the velocity of v to the laser cutting platform (7) beneath the laser cutting device (6);
b) positioning the starting point of cutting, driven by X-axis servo motor and Y-axis servo motor, the laser cutting head (18) is moved to the starting point of cutting, and driven by Z-axis servo motor, the laser cutting head (18) is moved to an appropriate height from the strip material to meet the requirement of laser cutting;
c) velocity stacking, assuming that the running velocity of X-axis servo motor and Y-axis servo motor are vₓ and v_{y} respectively when cutting static strip, then, the running velocity of X-axis servo motor and Y-axis servo motor are vₓ+v, v_{y} respectively when cutting moving strip;
d) executing pattern cutting, driven by the servo motor in the laser cutting device (6), the laser cutting head (18) operates pattern cutting at the stacked velocity;
e) returning to the starting point of cutting, after one cutting cycle is finished, the laser cutting head (18) returns to the starting point under the driving of a servo motor for the next cycle; and
f) repeating steps b), c), d) and e) until the strip processing completes.

7. The decoiling and blanking machine using laser cutting technology according to claim 2, wherein the laser cutting device (6) comprises a frame (11), a movable transverse beam (12) and a movable support (17), a slider (30) and a laser cutting head (18), wherein the movable transverse beam (12) runs on the X-axis; the movable transverse beam (12) runs in the direction of X-axis under the drive of the X-axis servo motor.
the movable transverse beam (12) is mounted with the movable support (17), the moving direction of which is defined at the Y-axis, the movable support (17) runs in the direction of Y-axis under the drive of the Y-axis servo motor; the movable support (17) is provided with the slider (30) which is driven by the Z-axis servo motor, and the laser cutting head (18) is fixed on the slider (30).

8. The decoiling and blanking machine using laser cutting technology according to claim 2, wherein the laser cutting platform (7) comprises a supporting transverse beam (37) containing a left transverse beam (43) and a right transverse beam (44) to be set in parallel, wherein the two transverse beams are set with a driving shaft (40), a driven shaft (42), a conveying chain (38) or a conveying belt and a tension adjusting device (45); the driving shaft (40) and the driven shaft (42) are respectively set at both ends of the two transverse beams, the driving shaft (40) and the driven shaft (42) are provided a gear (41) which drives the conveying chain or the conveying belt; the conveying chain (38) or the conveying belt are equally spaced by several supporting racks (39) on the outside surface, the two transverse beams are set with a horizontal board which supports the conveying chain (38) or the conveying belt; a powered roller (46) which is set at one end of the driving shaft (40) connects with a power unit.

9. The decoiling and blanking machine using laser cutting technology according to claim 2, further comprising a feeding device (1) used to convey the coil stock to the decoiler (2), wherein the feeding device (1) consists of a coil cradle (1-1), a car body (1-2), a guide rail (1-3) and a driving motor (1-4).
